(19) United States
(12) Patent Application Publication
(10) Pub. No.: US 2026/0109383 A1
(43) Pub. Date: Apr. 23, 2026

(54) Soil Collecting Device

(71) Applicants: Daniela Loreno, Mono (CA); Steve Loreno, Mono (CA)

(72) Inventors: Daniela Loreno, Mono (CA); Steve Loreno, Mono (CA)

(21) Appl. No.: 18/921,527

(22) Filed: Oct. 21, 2024

(51) Int. Cl. B62B 3/10; B62B 3/00; B62B 5/06; E21B 41/00

(52) U.S. Cl. CPC B62B 3/10; B62B 3/002; B62B 5/06; B62B 5/067; E21B 41/00

(57) ABSTRACT

A soil collecting device is provided. The soil collecting device includes a housing with a floor and one or more sidewalls, including a rear wall and a front wall. The housing includes a soil opening that is offset from the center of the floor. The soil opening allows an auger to pass therethrough wherein the housing collects soil displaced during auger drilling for fence posts and similar applications. Handle apertures on the sidewalls allow for easy lifting and maneuvering. In some embodiments, the handle apertures are aligned on opposing sidewalls to receive a forklift therethrough. In other embodiments, a plurality of wheels and a towing handle extend from the housing for manual mobility. The soil collecting device collects and transports soil directly from post holes, eliminating the need for manual shoveling and reducing labor strain.

### BACKGROUND OF THE INVENTION

The present invention relates to soil collection devices used in post-hole digging operations. More specifically, the invention pertains to a soil collecting device designed to simplify and improve the process of gathering and transporting soil displaced during auger drilling for fence posts, signposts, and similar applications.

In the construction and landscaping industries, the task of drilling post holes is both common and labor-intensive. Traditionally, this process involves the use of an auger to excavate soil, which is then manually collected and transported away from the site. The soil typically falls back into the hole or is scattered around the excavation site, necessitating additional labor to clean up and transport the soil to a desired location. This method is time-consuming and physically demanding, often leading to inefficiencies on the job site and increased labor costs.

Existing solutions have attempted to address these issues through various means. Some devices incorporate trays or buckets that attach to the auger to catch the displaced soil. While these devices offer some improvement over manual collection, they have significant limitations. The capacity of such trays or buckets is often limited, requiring frequent emptying and thus interrupting the workflow. Moreover, these attachments can be cumbersome to use, particularly when dealing with uneven terrain or when precise hole placement is required. Additionally, the design of many of these devices does not adequately account for the ergonomic challenges faced by workers, leading to increased physical strain and potential injury.

Another approach has been the use of automated soil extraction systems, which can remove soil directly from the hole as it is being drilled. However, these systems tend to be complex and expensive, making them impractical for many small to medium-sized operations. Furthermore, they often require specialized equipment that is not easily adaptable to different job sites or varying soil conditions. As a result, many construction and landscaping professionals continue to rely on manual methods, despite the clear drawbacks in terms of efficiency and worker health.

Therefore, there exists a need for a soil collecting device that addresses the shortcomings of existing methods by providing a simple, effective solution that minimizes manual labor, reduces physical strain, and enhances overall job site efficiency. The present invention provides a device that not only collects soil efficiently as it is displaced but also facilitates easy transportation and disposal, thereby streamlining the post-hole digging process and reducing the likelihood of worker injury.

In light of the devices disclosed in the known art, it is submitted that the present invention substantially diverges in design elements and methods from the known art and consequently it is clear that there is a need in the art for an improvement for a soil collecting device. In this regard the instant invention substantially fulfills these needs.

### SUMMARY OF THE INVENTION

In view of the foregoing disadvantages inherent in the known types of soil collecting devices now present in the known art, the present invention provides a new soil collecting device wherein the same can be utilized for gathering and transporting soil displaced during auger drilling for fence posts, signposts, and similar applications.

It is an objective of the present invention to provide a soil collecting device comprising a housing with a floor, one or more sidewalls, a rear wall, and an angled front wall. The housing is designed to capture soil directly from post holes as it is being drilled, wherein the angled front wall allows the soil to be easily emptied from the housing, thereby reducing the need for manual shoveling and minimizing the scattering of soil around the excavation site.

It is an objective of the present invention to provide a soil collecting device that includes handle apertures on the sidewalls to facilitate easy lifting and maneuverability. The handle apertures are configured to accommodate both manual handling and forklift transportation, allowing the device to be easily moved across different terrains and job sites. The handle apertures reduce physical strain on workers and improves overall job site productivity.

It is an objective of the present invention to provide a soil collecting device equipped with wheels and a towing handle for enhanced mobility. The wheels are positioned at the corners of the housing to ensure stability during movement, while the towing handle allows for easy transportation of the device when filled with soil.

It is an objective of the present invention to provide a soil collecting device that includes a soil opening with a reducer ring system. The reducer ring system allows for the adjustment of the soil opening size, enabling the device to accommodate different auger diameters and soil volumes.

It is therefore an object of the present invention to provide a new and improved soil collecting device comprising that has all of the advantages of the known art and none of the disadvantages.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings.

FIG. 1 shows a perspective view of an embodiment of the soil collecting device.

FIG. 2 shows a perspective view of an alternate embodiment of the soil collecting device.

FIG. 3 shows an exploded view of the soil opening reducer rings of the soil collecting device.

FIG. 4 shows a perspective view of an alternate embodiment of the soil collecting device in use.

### DETAILED DESCRIPTION OF THE INVENTION

Reference is made herein to the attached drawings. For the purposes of presenting a brief and clear description of the present invention, the preferred embodiment will be discussed as used for gathering and transporting soil displaced during auger drilling for fence posts, signposts, and similar applications. The figures are intended for representative purposes only and should not be considered to be limiting in any respect.

Reference will now be made in detail to the exemplary embodiment(s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment”, “first embodiment”, “second embodiment”, or “third embodiment” does not necessarily refer to the same embodiment. Additionally, reference to a “device” can refer to a single guard member or more than one guard members.

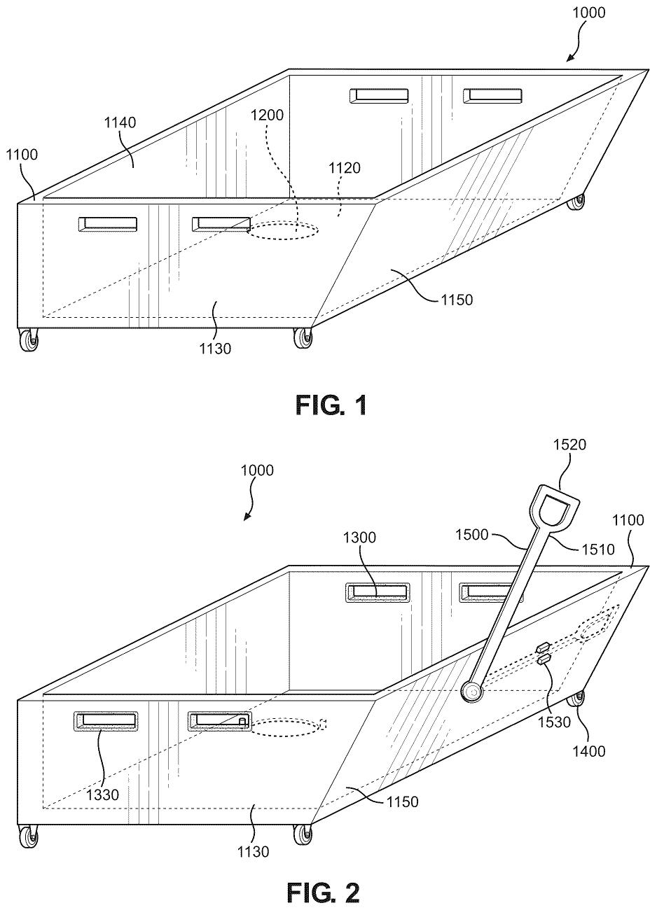

Referring now to FIG. 1, there is shown a perspective view of an embodiment of the soil collecting device. The soil collecting device 1000 is configured to collect and transport soil that is displaced during the drilling of post holes, thereby improving the efficiency of the overall digging process and reducing the physical strain on workers. In the illustrated embodiment, the soil collecting device 1000 comprises a housing 1100 having a floor 1120, a pair of opposing sidewalls 1130, a rear wall 1140 and a front wall 1150. A soil opening 1200 is disposed within the floor 1100 to allow the auger and soil to pass therethrough. In the illustrated embodiment, the floor 1120 of the housing 1100 comprises a substantially rectangular cross-sectional shape. However, in alternate embodiments, the floor and the overall shape of the housing comprise any suitable cross-sectional shape. The sidewalls 1130, the rear wall 1140 and the front wall 1150 each extend from the floor 1120, wherein the rear wall 1140 and sidewalls 1130 form a substantially ninety-degree interior angle with the floor 1120. However, in alternate embodiments, the sidewalls and/or rear wall are angled inwards are outwards from the housing. The front wall 1150 is slanted or angled outwards, such that an interior angle between the floor and the front wall is greater than 90 degrees. The angled front wall 1150 allows soil to be more easily removed from the interior of the housing 1100 when tilting or lifting a rear end of the housing 1100 towards the front wall 1150.

In the illustrated embodiment, the sidewalls 1130 and rear wall 1140 are between five to fifteen inches in height. A width and length of the floor 1120 are between two to six feet. However, in alternate embodiments, the housing 1100 comprises any suitable dimension for receiving soil from a post-digging operation. The housing 1100 is constructed primarily from galvanized steel to ensure durability and resistance to corrosion, particularly in outdoor environments where the device may be exposed to moisture and varying weather conditions. Galvanized steel is chosen for its robust strength and its protective zinc coating, which significantly reduces the risk of rust and extends the lifespan of the soil collecting device 1000.

In the illustrated embodiment, the soil opening 1200 is offset from a center of the housing 1100, towards the rear wall 1140, and comprises a diameter between six to sixteen inches. However, in alternate embodiments, the soil opening comprises any suitable diameter size configured to receive an auger therethrough within a close tolerance thereof. The offset positioning of the soil opening 1200 serves to direct the flow of displaced soil towards the center of the housing 1100 as it is collected during drilling. As the auger drills through the soil and displaces it upward, the soil naturally falls through the offset opening and begins to accumulate centrally within the housing 1100. This centralized accumulation is crucial for maintaining balance and stability within the device, preventing uneven distribution of the soil, which could otherwise cause difficulty in handling or transporting the device.

Moreover, the offset soil opening configuration is significant when the soil collecting device 1000 is tilted towards the slanted front wall 1150 for unloading the collected soil. As the device 1000 is tilted forward, the soil that has been centrally compiled remains securely within the housing and is removed over the slanted front wall 1150. The rearward position of the soil opening 1200 ensures that the soil does not fall back through the opening 1200 during this tilting process. In this configuration, the position of the soil opening 1200 prevents the loss of soil and ensures that the removal process is clean and efficient without requiring additional manual intervention to reposition the soil within the housing.

The combination of the offset soil opening 1200 and the slanted front wall 1150 provides a controlled and predictable pathway for the soil during unloading. This combination minimizes the risk of soil spillage and enhances the overall usability of the device, particularly in job sites where maintaining a clean working area is important. In some embodiments, the floor is slanted downwards towards the front wall to further direct soil to the center of the housing.

Referring now to FIG. 2, there is shown a perspective view of an alternate embodiment of the soil collecting device. The sidewalls 1130 of the housing 1100 are equipped with a plurality of handle apertures 1300. The handle apertures 1300 are positioned on opposite sides of the housing 1100, aligned across from one another to facilitate balanced lifting and handling. In the illustrated embodiment, the handle apertures 1300 are rectangular in shape and are designed to accommodate manual handling or the insertion of forklift tines for mechanical lifting. However, in alternate embodiments, the handles apertures comprise any suitable shape. In some embodiments, the handle apertures include a padded layer 1330 on the interior surface to provide additional comfort and grip for workers.

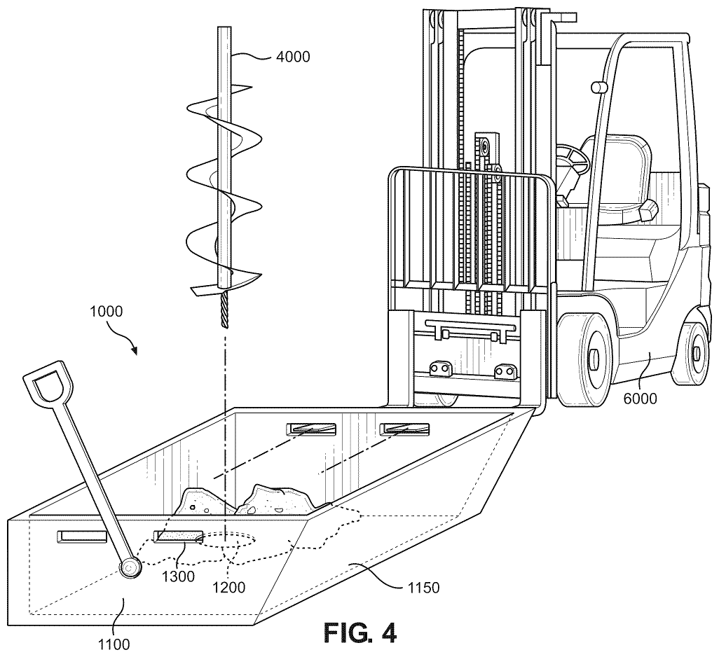

In the illustrated embodiment, the soil collecting device 1000 comprises a plurality of wheels 1400 secured to the housing 1100. Each wheel 1400 is positioned at a corner of the housing 1100 to provide stability and ease of movement across various terrains. In some embodiments, the wheels 1400 may be made from rubber or another resilient material to absorb shocks and provide smooth transportation. In some embodiments, such as seen in FIG. 4, the soil collecting device does not include wheels.

Additionally, in the illustrated embodiment, the soil collecting device 1000 includes a towing handle 1500 that is pivotally secured to the housing 1100. The towing handle comprises an elongated shaft 1510 with a grip 1520 at its distal end, allowing a user to easily maneuver the device 1000. The grip 1520 comprises an opening configured to receive a hand therethrough. The towing handle 1500 is configured to pivot and rotate freely, providing maximum flexibility and ease of use during transport. The pivotal connection between the towing handle and the housing is designed to allow full 360-degree rotation, enabling the handle to move horizontally, vertically, or at any angle in between. The towing handle's rotation is only limited by the physical boundaries of the housing itself. In one example, when the handle is rotated towards the housing, the handle's movement is naturally restricted by contact with the walls or floor of the housing 1100.

When not in use, the towing handle 1500 can be stored in a retainer 1530 mounted on the front wall 1150 of the housing 1100. In the illustrated embodiment, the retainer 1530 comprises of a pair of lips that secure the towing handle 1500 in place, with the elongated shaft 1510 aligned longitudinally with the front wall 1150. In alternate embodiments, the towing handle is positioned on any of the sidewalls of the housing. In some embodiments, the housing does not include a towing handle.

In one embodiment, the wheels and towing handle grip comprises a durable rubber or another impact-resistant material to provide stability and comfort during use. Additionally, the interior padding within the handle apertures may be composed of weather-resistant foam or another soft, resilient material to enhance user comfort while maintaining the integrity of the device under prolonged use.

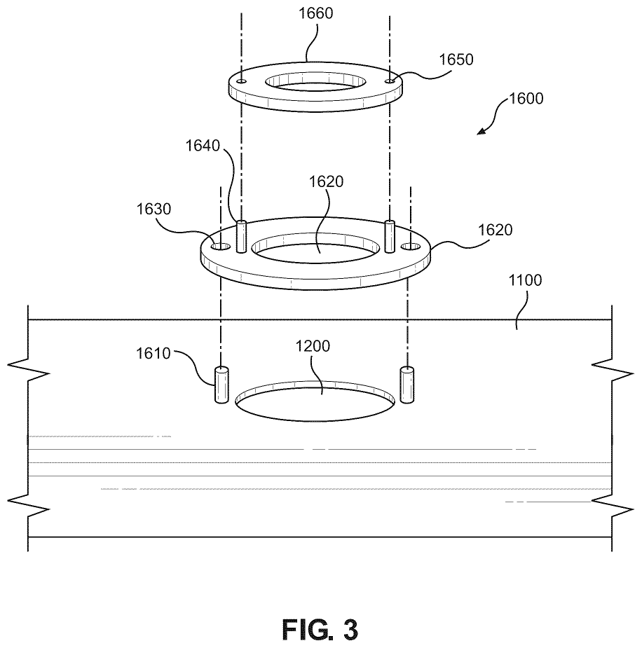

Referring now to FIG. 3, there is shown an exploded view of the soil opening reducer rings of the soil collecting device. In some embodiments, the soil collecting device comprises a reducer ring system 1600 having one or more soil opening reducer rings that removably and concentrically secure to the housing 1100 and one another. The reducer ring system comprises a plurality of tabs 1610 that extend from the floor 1100 around the perimeter of the soil opening 1200. These tabs 1610 are designed to secure a first soil opening reducer ring 1620, which is an interchangeable component that adjusts the size of the soil opening to accommodate different auger diameters. The first soil opening reducer ring 1620 comprises a second soil opening 1630 with a smaller diameter than the primary soil opening 1200 of the housing 1100. The first soil opening reducer ring 1620 is attached to the tabs 1610 via apertures 1630 that align with the tabs, ensuring a secure fit.

In certain embodiments, the soil collecting device may include multiple soil opening reducer rings, each with a progressively smaller diameter. This allows the device to be used with a variety of augers, providing versatility for different post-hole drilling scenarios. The reducer rings are also designed to be easily replaceable, enabling users to switch between them as needed. In the illustrated embodiment, each size opening reducer ring is thin and composed of a substantially similar material to the housing 1100. The first soil opening reducer ring 1620 comprises both apertures for securing to the tabs 1610 of the housing 1100 and a second set of tabs 1640 for securing to a second set of apertures 1650 of a second soil opening reducer ring 1660. In some embodiments, a desired tolerance between the soil opening diameter and the diameter of the auger is 0.5 inches to 2 inches.

Referring now to FIG. 4, there is shown a perspective view of an alternate embodiment of the soil collecting device in use. In operation of the soil collecting device 1000, a user first positions the housing 1100 over the desired post-hole location, aligning the soil opening 1200 with the point where the auger 4000 will drill. The user may attach the appropriate soil opening reducer ring, if necessary, based on the diameter of the auger being used. Once the device is in place, the user begins the drilling process, allowing the auger to displace soil directly into the housing 1100 through the soil opening 1200.

As the auger drills, the soil is collected within the housing 1100, preventing it from scattering around the area. When the housing 1100 is filled to capacity or the drilling is complete, the user may lift the device 1000 using the handle apertures 1300 or move it using the towing handle or use the towing handle and wheels 1400 to transport the soil. Alternatively, a forklift 6000 can be used to move the housing 1100 to a dumping location. The outwardly angled front wall 1150 of the housing 1100 allows for easy removal of the collected soil by tipping the housing 1100 forward or using a shovel to scoop out the contents.

In embodiments where multiple post holes are being drilled, the user can easily reposition the soil collecting device 1000 by either carrying it manually or towing it to the next location. The design of the device ensures that soil collection is efficient, reducing the need for additional clean-up work and minimizing the physical strain on workers.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, device and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A soil collecting device, comprising:
a housing having a floor and one or more sidewalls, wherein the one or more sidewalls includes a rear wall and a front wall that each extend from the floor;
a soil opening disposed through the floor, wherein the soil opening is offset from a center of the housing towards the rear wall;
wherein an interior angle between the floor and the front wall is greater than 90 degrees, wherein the front wall is angled outwards.

2. The soil collecting device of claim 1, further comprising a plurality of handle apertures disposed on the one or more sidewalls.

3. The soil collecting device of claim 2, wherein the one or more sidewalls comprise a pair of the handle apertures aligned across from one another, wherein a first pair of aligned handle apertures and a second pair of aligned handle apertures are each configured to receive a fork from a forklift.

4. The soil collecting device of claim 2, wherein each of the plurality of handles comprises a rectangular shaped cross-section.

5. The soil collecting device of claim 2, further comprising a padded layer on an interior of each of the plurality of handle apertures.

6. The soil collecting device of claim 1, wherein the floor of the housing comprises a substantially rectangular cross-sectional shape.

7. The soil collecting device of claim 6, wherein the rear wall forms a ninety-degree interior angle with the floor.

8. The soil collecting device of claim 1, further comprising a plurality of wheels secured to the housing, the plurality of wheels configured to transport the housing.

9. The soil collecting device of claim 8, wherein each of the plurality of wheels extends from a corner of the housing.

10. The soil collecting device of claim 9, further comprising a towing handle configured to assist with the transporting the housing.

11. The soil collecting device of claim 10, wherein the towing handle is pivotally secured to the housing.

12. The soil collecting device of claim 11, wherein the towing handle comprises an elongated shaft and a grip extending from a distal end of the elongated shaft.

13. The soil collecting device of claim 12, wherein the grip comprises an opening configured to receive a hand therethrough.

14. The soil collecting device of claim 12, further comprising a retainer extending from the housing and configured to receive the towing handle in a stored configuration.

15. The soil collecting device of claim 14, wherein the retainer comprises a pair of lips extending from the front wall of the housing.

16. The soil collecting device of claim 15, wherein the stored configuration the elongated shaft is disposed between the pair of lips of the retainer and longitudinally aligned with the front wall of the housing.

17. The soil collecting device of claim 1, wherein a plurality of tabs extends from the floor and are disposed along a perimeter of soil opening, wherein the plurality of tabs are configured to secure to a soil opening reducer ring.

18. The soil collecting device of claim 17, wherein the soil opening reducer ring comprises a second soil opening having a diameter smaller than a diameter of the soil opening of the housing and a plurality of apertures each configured to align with and receive a tab of the plurality of tabs therethrough.

19. The soil collecting device of claim 18, further comprising a second soil opening reducer ring having a third soil opening with a diameter smaller than the diameter of the second soil opening.

20. The soil collecting device of claim 19, wherein the second soil opening reducer ring comprises a plurality of second tabs extending from an upper surface thereof and configured to extend through a plurality of second apertures disposed around a perimeter of the second soil opening reducer ring.
